(19) United States
(12) Patent Application Publication
(10) Pub. No.: US 2012/0241573 A1
(43) Pub. Date: Sep. 27, 2012

(54) Fastener

(76) Inventor: Kelly Koller, Clintonville, WI (US)

(21) Appl. No.: 13/330,263

(22) Filed: Dec. 19, 2011

Related U.S. Application Data
(60) Provisional application No. 61/466,004, filed on Mar. 22, 2011.

(51) Int. Cl. F16M 13/02; F16M 13/00

(52) U.S. Cl. 248/220.21; 248/315

(57) ABSTRACT

An apparatus comprises a closed loop member comprising a round loop being configured to be operable for supporting a material inserted into an interior space formed by the round loop. The round loop comprises a segment being configured to be operable for opening and closing a portion of the body of the round loop to enable the material to be passed through the body of the round loop into the interior space. A closing mechanism is configured to be operable for urging the segment to be in a closed position. An attachment mechanism is joined to the closed loop member. The attachment mechanism is configured to be operable for joining to a structure, in which the closed loop member is operable for supporting the material to the structure.

### CROSS-REFERENCE TO RELATED APPLICATIONS

The present Utility patent application claims priority benefit of the U.S. provisional application for patent serial number 61466004 filed on Mar. 22, 2011 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to fasteners. More particularly, the invention relates to a fastener with a clasp mechanism.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Closed loop fasteners such as screw eyes and eyebolts have been widely used in a variety of applications from home hobby and household work to providing an anchorage point in industrial and construction settings. Such fasteners, varying in their size and type of threads are often used to attach material to a point or series of points along a path.

By way of educational background, an aspect of the prior art generally useful to be aware of is that prior art includes a bracket in the shape of a loop for mounting wires and cables and also includes an eyebolt. Clasping mechanisms that are in the shape of a circular or oval loop have been applied in jewelry such as in hinged pull-out clasps. Lever-back earring clasps are another means that enables a loop shaped wire to open and close by pulling out the clasp on a hinge. These clasps are typically intended to provide a means of opening and closing a loop shape to hang an ornament through an ear or to attach ends of a necklace or bracelet. Similarly, push-in clasping mechanisms have been applied to a shape in and of itself for climbing activities and lifting objects.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1a through 1c illustrate an exemplary fastener with a clasp mechanism, in accordance with an embodiment of the present invention. FIG. 1a is a front perspective view of the fastener in an open position. FIG. 1b is a front perspective view of the fastener in a closed position, and FIG. 1c is a front perspective view of the clasp mechanism;

FIGS. 2a and 2b illustrate an exemplary fastener with a clasp mechanism, in accordance with an embodiment of the present invention. FIG. 2a is a front perspective view of the fastener, and FIG. 2b is an exploded view of a spring within the clasp mechanism;

FIGS. 3a and 3b illustrate an exemplary fastener with a clasp mechanism, in accordance with an embodiment of the present invention. FIG. 3a is a front perspective view of the fastener in an open position, and FIG. 3b is a front perspective view of the fastener in a closed position;

FIGS. 4a through 4c illustrate exemplary fasteners with examples of alternative clasp mechanisms, in accordance with embodiments of the present invention. FIB 4a is a front perspective view of a fastener with a clasp mechanism that uses a collar to secure a metal strip. FIB 4b is a front perspective view of a fastener with a clasp mechanism that uses a metal wire, and FIG. 4c is a front perspective view of a fastener with a straight clasp mechanism;

FIG. 5 is a front perspective view of a U-shaped fastener with a clasp mechanism, in accordance with an embodiment of the present invention;

FIG. 6 is a front perspective view of a U-shaped fastener with a clasp mechanism, in accordance with an embodiment of the present invention;

FIG. 7 is a front perspective view of a circular fastener with a clasp mechanism, in accordance with an embodiment of the present invention;

FIG. 8 is a front perspective view of a circular fastener with a clasp mechanism, in accordance with an embodiment of the present invention;

FIG. 9 is a front perspective view of a U-shaped fastener with a clasp mechanism, in accordance with an embodiment of the present invention; and

FIG. 10 is a front perspective view of a rectangular fastener with a clasp mechanism, in accordance with an embodiment of the present invention.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A practical embodiment of the present invention provides a device for holding material along a series of points or hanging singular objects comprising a closed loop shape that has a clasp mechanism that opens and closes a segment of the loop for inserting and removing material and has a means of fastening to another material or surface. In practical embodiments, the mechanism of the clasp can be designed to open out or push in, depending on what the fastener is intended to hold. Many practical embodiments may be implemented to provide fasteners that comprise hinged clasps of a large variety of sizes, screw and bolt threads and eye shapes to be used in a wide variety of light duty to heavy-duty applications from industrial and home wiring to hobbies.

Current fasteners that are designed to hold material in position such as, but not limited to, screw eyes and eyebolts do not have a means for quickly repositioning or removing the material when a series of fasteners are needed, such as, but not limited to, with rope, fishing line, wires, holiday lights, Ethernet cable, etc. In the occasion where a user is fastening a material along several points and needs to make one or more adjustments to the route, the user must pull the material out of all of the fasteners, make the adjustments and feed the material back through the fasteners. A practical embodiment of the present invention allows for quick repositioning of the material rather than removing the material in the entire series of attachments, which saves the user time as the user only has to make adjustments at the point of error. Many practical embodiments may improve the speed and ease in which a user is able to feed material through a singular point as well. For example, without limitation, when hanging an object such as, but not limited to, a hanging basket to a ceiling or soffet board most current hooks are not closed, allowing the object to come off. By closing the clasp in many practical embodiments, a user can generally prevent the object from falling off of the fastener. Also, when attaching rope or other such material to a single point to create a tie-out position for a dog or horse using many conventional means, a user must loop and tie the material through an eye on a stake, taking time. A practical embodiment enables the user to open the fastener with the clasping mechanism, move it, put the material back in and close the fastener; allowing for a much faster adjustment.

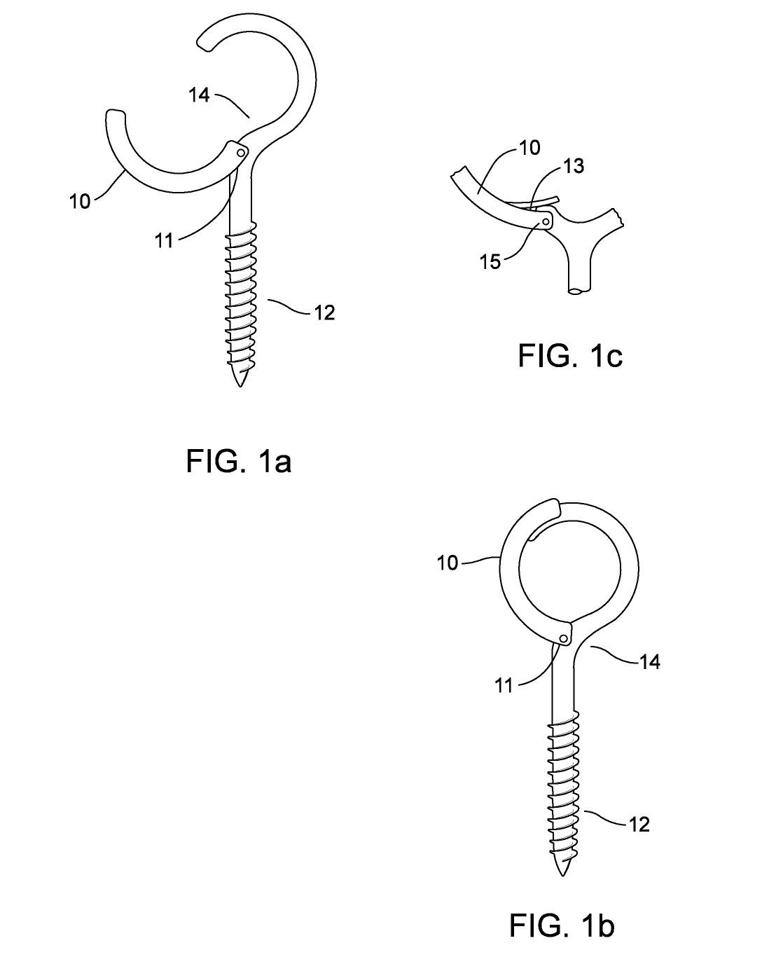

FIGS. 1a through 1c illustrate an exemplary fastener with a clasp mechanism 10, in accordance with an embodiment of the present invention. FIG. 1a is a front perspective view of the fastener in an open position. FIG. 1b is a front perspective view of the fastener in a closed position, and FIG. 1c is a front perspective view of clasp mechanism 10. In the present embodiment, the fastener is in the shape of a screw eye comprising screw threads 12. It is contemplated that various different fastening means may be used in some alternate embodiments including, without limitation, bolt threads, suction cups, magnets, adhesives, etc. Referring to FIG. 1a in the present embodiment, when pulled away from the screw eye, clasp mechanism 10 rotates about a hinged joint 11 to open the screw eye. Referring to FIG. 1c, tension on hinged joint 11 is provided by a return mechanism 13, which is small, thin, rectangular piece of metal that fits within a notch 15 in clasp mechanism 10. When clasp mechanism 10 is pulled open, return mechanism 13 presses on a shank 14 of the fastener, creating a spring like tension that, when pulled fully, causes clasp mechanism 10 to remain open. Referring to FIG. 1b, when moving into the closed potion and once clasp mechanism 10 overcomes a certain point, the tension from return mechanism 13 causes clasp mechanism 10 to snap shut.

Clasp mechanism 10 is curved to complete the round loop of the screw eye of the fastener when in the closed position. In addition, notch 15 enables clasp mechanism 10 to overlap the loop so that the transition from clasp mechanism 10 to the loop is relatively smooth. The tension from return mechanism 13 pushes clasp mechanism 10 onto the loop to hold clasp mechanism 10 in the closed position. In some alternate embodiments, the clasp mechanism may be held in the closed position using various different means including, without limitation, a notch on the loop into which the clasp mechanism fits, a tab on the loop that fits into a slot on the clasp mechanism, a tab on the clasp mechanism that fits into a slot on the loop, etc. Moreover, the clasping mechanisms in some alternate embodiments may be implemented in various different shapes. For example, without limitation, in some alternate embodiments, the clasp mechanism may be a solid curved rod or a solid straight rod. In the present embodiment, the fastener may be made of a variety of suitable materials such as, but not limited to, various different metals or plastics.

In typical use of the present embodiment, a user attaches the fastener to an object using screw threads 12. The user may then insert a material such as, but not limited to, wire, cable or rope into the screw eye of the fastener. If this material is being fed through a series of fasteners and a portion of the material needs to be removed or repositioned, the fastener allows the user to open clasping mechanism 10, remove or move the material, place the material back in the fastener, and close clasp mechanism 10. This typically provides a faster adjustment than removing the material from multiple fasteners and rerouting the material back through the fasteners. Also, the closed loop generally holds the material securely in place. Fasteners according to the present embodiment and some alternate embodiments may be useful in a wide variety of applications. For example, without limitation, automated manufacturing systems fabricators may find these embodiments useful to route cable and wire. Hobbyists may find these embodiments useful any place a screw eye would be used such as, but not limited to, in quilting or on fishing poles for fishing line. In home improvement these embodiments may be useful in a number of tasks aforementioned and in various other tasks such as, but not limited to, hanging singular objects, holding tool boxes or buckets on or near ladders, hanging draperies, etc.

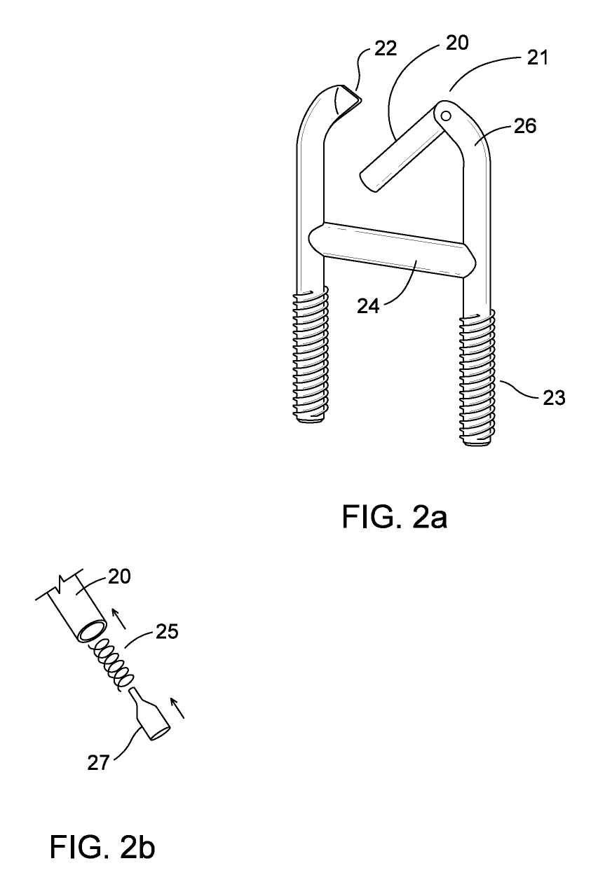

FIGS. 2a and 2b illustrate an exemplary fastener with a clasp mechanism 20, in accordance with an embodiment of the present invention. FIG. 2a is a front perspective view of the fastener, and FIG. 2b is an exploded view of a spring 25 within clasp mechanism 20. In the present embodiment, the fastener has a U shape, and clasp mechanism 20 pushes in about a hinged joint 21. Referring to FIG. 2b, tension is provided by spring the 25 within clasp mechanism 20. In one embodiment, the spring fits loose inside the hole in the cylinder-shaped portion of the clasp. A portion of a shank 26 near hinged joint 21 comprises a notch (not shown) that holds a tab 27 that is inserted into spring 25. As clasp mechanism 20 is pressed down, tension on spring 25 creates potential energy that, when pressure is removed, snaps clasp mechanism back into the closed position, where it is stopped by a tab 22 which is mated with an similarly shaped cutout (not shown) in clasp mechanism 20. The tension provided by spring 25 pushes this cutout onto tab 22 to hold clasp mechanism 20 in place. In some alternate embodiments the clasp mechanism may be held in the closed position using various different means such as, but not limited to, a notch in the shank of the fastener into which the clasp mechanism fits, a collar that slides over the meeting point of the shank and the clasp mechanism, magnets, etc. In the present embodiment, the fastener comprises bolt threads 23 as the fastening means; however, various different fastening means may be used in some alternate embodiments including, without limitation, screw threads, suction cups, magnets, etc. In the present embodiment a cross member 24 holds the shanks of the fastener together. The fastener may be made of a variety of suitable materials such as, but not limited to, various different metals or plastics.

In typical use of the present embodiment, the push-in motion of clasp mechanism 20 enables a user with gentle pressure to open the loop on the fastener and have clasp mechanism 20 snap back by itself, quickly and securely. Having a push-in clasp mechanism 20 on a fastener enables the user to easily push an item such as, but not limited to, wire, cable or rope into the loop to secure the item.

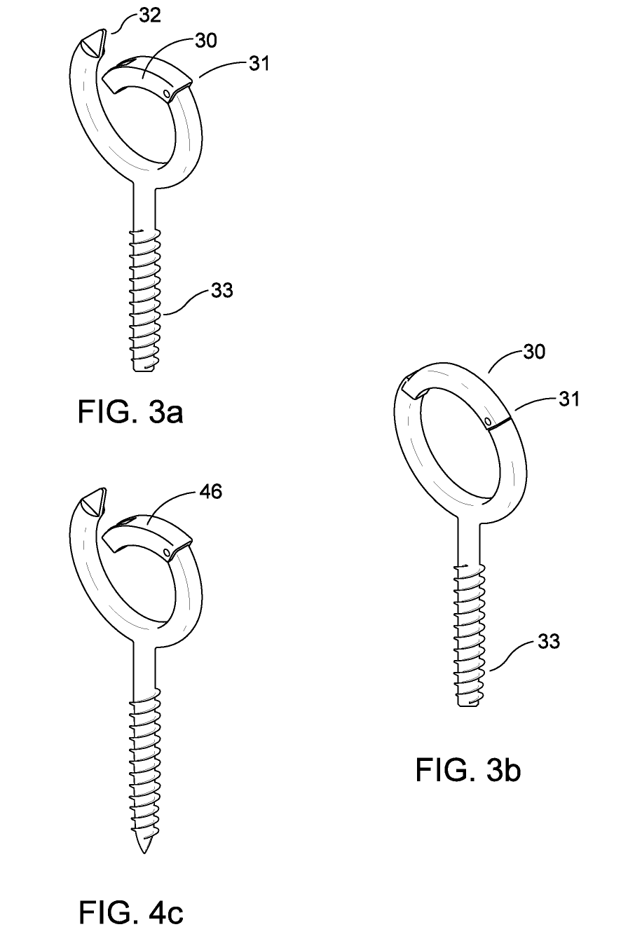

FIGS. 3a and 3b illustrate an exemplary fastener with a clasp mechanism 30, in accordance with an embodiment of the present invention. FIG. 3a is a front perspective view of the fastener in an open position, and FIG. 3b is a front perspective view of the fastener in a closed position. In the present embodiment, the closed loop shape of the fastener is circular, with clasp mechanism 30 being shaped accordingly to complete the circle. Clasp mechanism 30 is spring loaded and pushes into the loop about a hinged joint 31. Clasp mechanism 30 comprises a slot (not shown) at the end opposite hinged joint 31 that fits onto a tab 32 on the loop to hold clasp mechanism 30 in the closed position. The fastener comprises bolt threads 33 as the fastening means. The fastener may be made of a variety of suitable materials such as, but not limited to, various different metals or plastics.

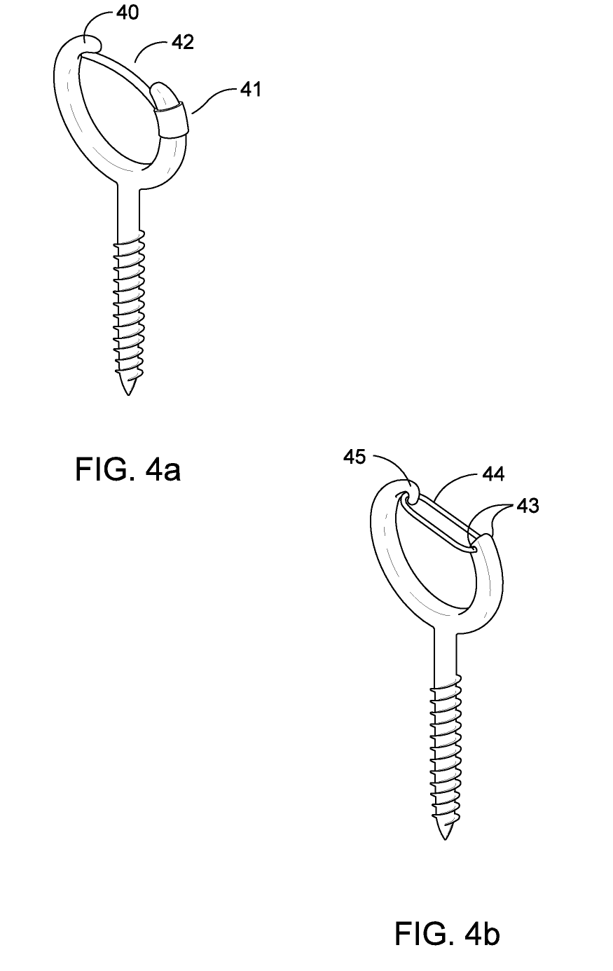

Those skilled in the art, in light of the teachings of the present invention, will readily recognize that a multiplicity of suitable clasping mechanisms may be used in some alternate embodiments of the present invention. FIGS. 4a through 4c illustrate exemplary fasteners with examples of alternative clasp mechanisms, in accordance with embodiments of the present invention. FIB 4a is a front perspective view of a fastener with a clasp mechanism that uses a collar 41 to secure a metal strip 42. FIB 4b is a front perspective view of a fastener with a clasp mechanism that uses a metal wire 44, and FIG. 4c is a front perspective view of a fastener with a straight clasp mechanism 46. Referring to FIG. 4a, when pressed down, metal strip 42 creates tension as held by collar 41 allowing strip 42 to spring back to the closed position when released. Strip 42 presses against an eye 40 of the loop when in the closed position. In some alternate embodiments this strip may be made of materials other than metal including, without limitation, various different plastics. Furthermore, some alternate embodiments may be implemented in which the strip is secured to the loop using means other than a collar such as, but not limited to, screws, bolts, welding, adhesives, etc.

Referring to FIG. 4b, metal wire 44 is attached at two juxtaposed points 43 on one end of the loop and rests against an eye 45 at the other end of the loop. When pressed down then released, metal wire 44 naturally springs back by tension created at points 43. In some alternate embodiments, various different materials may be used for the clasp mechanism such as, but not limited to, various different plastics.

Referring to FIG. 4c, the fastener comprises an alternatively shaped loop, which is flat on the top. The flat top of the loop is created by straight clasp mechanism 46. Clasp mechanism 46 functions similarly to clasp mechanism 30 shown by way of example in FIGS. 3a and 3b. It is contemplated that the clasp mechanisms in some alternate embodiments may have various different shapes. For example, without limitation, in some alternate embodiments the clasp mechanism may follow the shape of the loop. In other alternate embodiments, the clasp mechanism may comprise a bend or notch in which an item may rest while in position in the fastener.

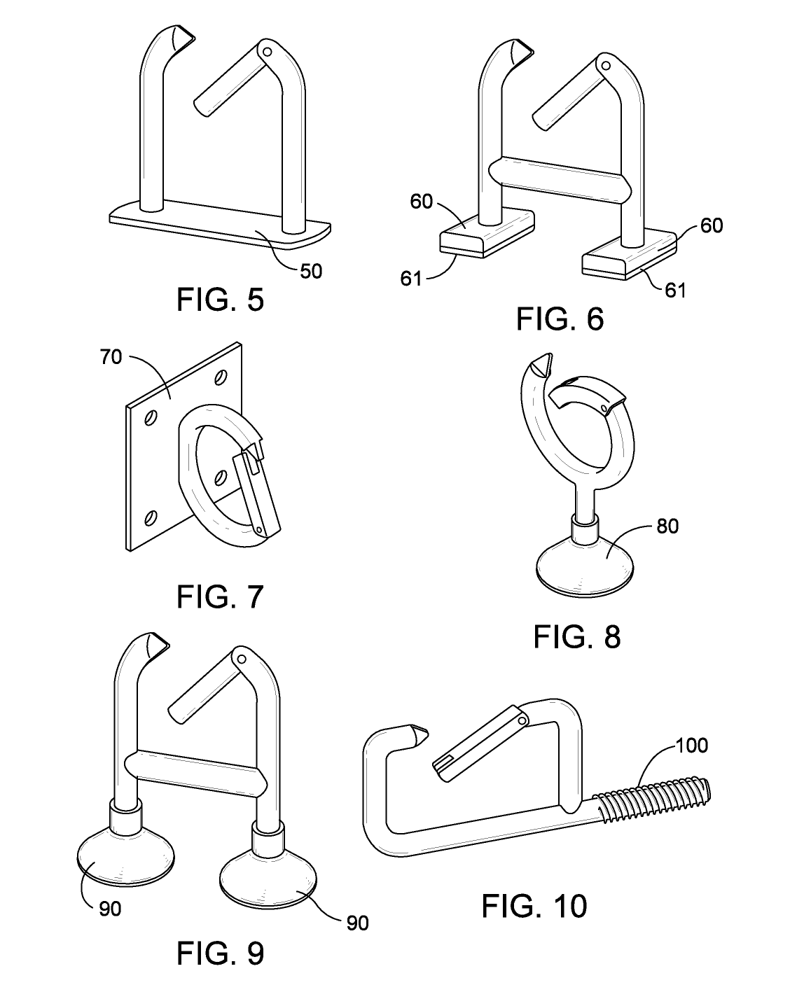

Those skilled in the art, in light of the teachings of the present invention, will readily recognize that fasteners in some alternate embodiments may be implmeneted in a multiplicity of suitable closed loop shapes including, without limitation, rectangular, oval or triangular shapes and with a multiplicity of suitable fastening means such as, but not limited to, magnets, adhesives, brackets, suction cups, etc. FIGS. 5 through 10 illustrate some non-limiting examples of fasteners with a variety of shapes and fastening means.

FIG. 5 is a front perspective view of a U-shaped fastener with a clasp mechanism, in accordance with an embodiment of the present invention. In the present embodiment, the shanks of the fastener are welded to a metal base 50 which houses a magnet. This embodiment is contemplated to be advantageous to someone who works in building industrial systems which often have metal structural components on which wiring must be installed. The clasp portion of the fastener makes re-routing wire easy, and the magnet in base 50 makes it easy to re-position the fastener on any metal surface or object.

FIG. 6 is a front perspective view of a U-shaped fastener with a clasp mechanism, in accordance with an embodiment of the present invention. In the present embodiment, the body of the fastener is made of plastic, making it lighter. Added to the overall shape of the fastener are supports 60 allowing the fastener to be attached at two points by means of adhesive or an adhesive material 61 such as, but not limited to, adhesive pads, adhesive wax, hook and loop material, etc.

FIG. 7 is a front perspective view of a circular fastener with a clasp mechanism, in accordance with an embodiment of the present invention. In the present embodiment, the circular shaped fastener is made of metal with a push-in-type clasp mechanism. The means of fastening is a bracket 70 which can be screwed to a surface.

FIG. 8 is a front perspective view of a circular shaped fastener with a clasp mechanism, in accordance with an embodiment of the present invention. In the present embodiment, the circular shaped fastener is made of plastic or metal and comprises a suction cup 80 for attaching the fastener to a surface, such as, but not limited to, a window, a wall or an appliance. This embodiment may be particularly useful for temporarily hanging a string of lights or other such decoration on a window or other interior surface.

FIG. 9 is a front perspective view of a U-shaped fastener with a clasp mechanism, in accordance with an embodiment of the present invention. In the present embodiment, the fastener may be made of plastic or metal and comprises suction cups 90 as a means of fastening it to a surface.

FIG. 10 is a front perspective view of a rectangular fastener with a clasp mechanism, in accordance with an embodiment of the present invention. In the present embodiment, the rectangular shaped loop may be useful for holding wider materials. The fastener comprises a shank with bolt threads 100 that can be bolted to a surface. In some alternate embodiments, the shank may be positioned elsewhere on the loop and may comprise alternate fastening means such as, but not limited to, screw threads, suction cups, adhesives, etc.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing a fastener with a clasp mechanism according to the present invention will be apparent to those skilled in the art. The invention has been described above by way of illustration, and the specific embodiments disclosed are not intended to limit the invention to the particular forms disclosed. For example, the particular implementation of the clasp may vary depending upon the particular type of return mechanism used. The return mechanisms described in the foregoing were directed to automatic implementations; however, similar techniques are to provide clasps that are manually moved between the open and closed positions. In some of these embodiments, attachment means such as, but not limited to, clips or clamps may be provided to hold the clasp in the closed position. Manual implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
a closed loop member comprising a round loop being configured to be operable for supporting a material inserted into an interior space formed by said round loop, said round loop comprising a segment being configured to be operable for opening and closing a portion of the body of said round loop to enable the material to be passed through the body of said round loop into the interior space;
a closing mechanism being configured to be operable for urging said segment to be in a closed position; and
an attachment mechanism being joined to said closed loop member, said attachment mechanism being configured to be operable for joining to a structure, in which said closed loop member is operable for supporting the material to the structure.

2. The apparatus as recited in claim 1, in which said segment rotates about a hinge point for opening and closing.

3. The apparatus as recited in claim 1, in which said segment and a portion of said round loop overlaps.

4. The apparatus as recited in claim 3, in which said round loop further comprises a notch where said segment and said portion of said round loop overlaps.

5. The apparatus as recited in claim 3, in which said round loop further comprises a flattened area where said segment and said portion of said round loop overlaps.

6. The apparatus as recited in claim 1, in which said attachment mechanism is further configured to be operable for joining to a surface of the structure.

7. The apparatus as recited in claim 2, in which said hinge point comprises a hinge joint.

8. The apparatus as recited in claim 1, in which said round loop comprises a cylindrical shape.

9. The apparatus as recited in claim 1, in which said closing mechanism comprises a spring mechanism disposed within a hollowed portion of said segment.

10. The apparatus as recited in claim 1, in which said segment rotates outward for opening said round loop.

11. The apparatus as recited in claim 10, in which said closing mechanism is further configured to be operable for urging said segment to be in an open position.

12. The apparatus as recited in claim 1, in which in which said round loop further comprises an eyelet shape.

13. An apparatus comprising:
means being configured to be operable for supporting a material inserted into an interior space formed by said supporting means, said supporting means being further configured to be operable for opening and closing a portion of the body of said supporting means to enable the material to be passed through the body into the interior space;
means being configured to be operable for urging said segment to be in a closed position; and
means being configured to be operable for joining to a structure, in which said supporting means supports the material to the structure.

14. An apparatus comprising:
a closed loop member comprising a round loop being configured to be operable for supporting a material inserted into an interior space formed by said round loop, said round loop comprising an eyelet shape, a segment being configured to be operable for opening and closing a portion of the body of said round loop to enable the material to be passed through the body of said round loop into the interior space, and a hinge joint about which said segment is rotatable for opening and closing, said segment and a portion of said round loop being further configured to be operable for overlapping, said round loop further comprising a notch and a flattened area where said segment and said portion of said round loop overlaps;
a closing mechanism being configured to be operable for urging said segment to be in a closed position; and
an attachment mechanism being joined to said closed loop member, said attachment mechanism being configured to be operable for joining to a structure, in which said closed loop member supports the material to the structure.

15. The apparatus as recited in claim 14, in which said attachment mechanism is further configured to be operable for joining to a surface of the structure.

16. The apparatus as recited in claim 14, in which said round loop comprises a cylindrical shape.

17. The apparatus as recited in claim 14, in which said closing mechanism comprises a spring mechanism disposed within a hollowed portion of said segment.

18. The apparatus as recited in claim 14, in which said segment rotates outward for opening said round loop.

19. The apparatus as recited in claim 18, in which said closing mechanism is further configured to be operable for urging said segment to be in an open position.

20. The apparatus as recited in claim 18, in which in which said closing mechanism comprises a flat member being joined to said segment.
